(19) United States
(12) Patent Application Publication
(10) Pub. No.: US 2026/0116567 A1
(43) Pub. Date: Apr. 30, 2026

(54) COOLING STRUCTURE

(71) Applicant: HONDA MOTOR CO., LTD., Tokyo (JP)

(72) Inventors: Azuki Ichikawa, Wako-shi (JP); Kenta Uchida, Wako-shi (JP)

(21) Appl. No.: 19/365,439

(22) Filed: Oct. 22, 2025

(30) Foreign Application Priority Data
Oct. 28, 2024 (JP) 2024-188784

(51) Int. Cl. B64D 33/08; B64C 11/00

(52) U.S. Cl. CPC B64D 33/08; B64C 11/00

(57) ABSTRACT

A cooling structure cools a propeller drive unit that is made to rotate, and thereby drives the propellers of an aircraft. The cooling structure is equipped with fans that supply a cooling air to an outer peripheral part of the propeller drive unit, and airflow straightening vanes that serve to straighten the cooling air.

### CROSS-REFERENCE TO RELATED APPLICATIONS

This application is based upon and claims the benefit of priority from Japanese Patent Application No. 2024-188784 filed on Oct. 28, 2024, the contents of which are incorporated herein by reference.

### BACKGROUND OF THE INVENTION

### FIELD OF THE INVENTION

The present invention relates to a cooling structure.

### DESCRIPTION OF THE RELATED ART

US 2021/0139157 A1 discloses a cooling structure for a rotor structural body. The cooling structure is equipped with a fan blade that is disposed downwardly of a rotor blade of a rotor blade structure. The fan blade is rotatably mounted on an upper part of a motor. By the motor being driven, the rotor blade and a rotor hub of the rotor structural body rotate. In addition, by the airflow generated by the rotation of the rotor blade being supplied to the motor by the fan blade, the motor is cooled.

### SUMMARY OF THE INVENTION

In the cooling structure of US 2021/0139157 A1, when the airflow generated by the rotor blade is pushed downwardly by the fan blade, the airflow swirls due to the rotation of the fan blade. Therefore, by the swirling of the airflow, a loss in pressure increases, and thereby the cooling performance for the motor decreases.

The present disclosure has the object of solving the aforementioned problem.

An aspect of the present disclosure is characterized by a cooling structure for cooling a propeller drive unit that rotates and drives an aircraft propeller, and is equipped with a fan that supplies a cooling air to an outer peripheral part of the propeller drive unit, and an airflow straightening vane that serves to straighten the cooling air.

According to the present disclosure, by the cooling air being straightened by the airflow straightening vane, an increase in the loss of pressure is suppressed, and the cooling air can effectively flow to the outer peripheral part of the propeller drive unit. Therefore, the cooling performance for the propeller drive unit can be enhanced.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is an overall configuration diagram of an aircraft equipped with a cooling structure according to an embodiment of the present disclosure;

FIG. 2 is a cross-sectional view of a first propeller device of the aircraft shown in FIG. 1;

FIG. 3 is a plan view of the first propeller device shown in FIG. 2;

FIG. 4 is an explanatory side view showing a cooling structure of the first propeller device;

FIG. 5 is an explanatory diagram showing a case in which a propeller drive unit is cooled by the cooling structure;

FIG. 6 is an explanatory diagram showing a case in which the propeller drive unit is cooled by a cooling structure according to an exemplary modification; and

FIG. 7 is a schematic diagram of a cooling system.

### DETAILED DESCRIPTION OF THE INVENTION

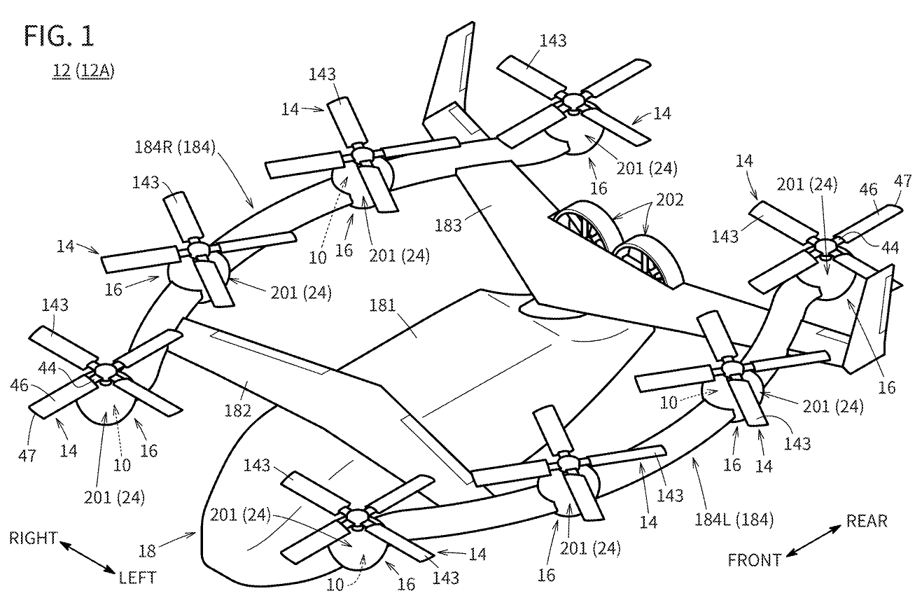

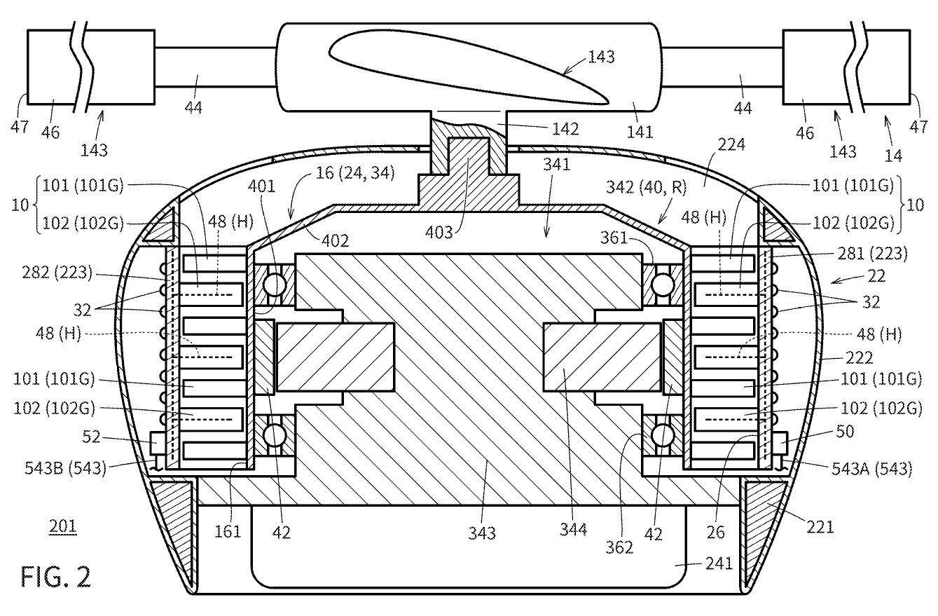

As shown in FIG. 1, a cooling structure 10 according to the present embodiment cools a propeller drive unit 16 (refer to FIG. 2) to cause propellers 14 of an aircraft 12 to be rotated and driven. The aircraft 12, for example, is an electric aircraft 12A. The electric aircraft 12A of the present embodiment is an eVTOL aircraft. However, the present disclosure can also be used in relation to a multicopter. Moreover, it should be noted that the aircraft 12 is not necessarily limited to being the electric aircraft 12A. For example, the aircraft 12 may be powered by an internal combustion engine.

At first, a description will be given concerning the aircraft 12. The aircraft 12 is equipped with an aircraft body 18, a plurality of first propeller devices 201, and a plurality of second propeller devices 202.

The aircraft body 18 is equipped with a fuselage 181, a front wing 182, a rear wing 183, and booms 184. The fuselage 181 is elongated in a frontward/rearward direction of the aircraft 12. The front wing 182 is disposed more frontwardly than a middle part in the frontward/rearward direction of the fuselage 181. The front wing 182 is connected to an upper part of the fuselage 181. The rear wing 183 is disposed more rearwardly than the middle part in the frontward/rearward direction of the fuselage 181.

The booms 184 are equipped with a right boom 184R and a left boom 184L. Each of the right boom 184R and the left boom 184L extends in the frontward/rearward direction of the aircraft body 18. The right boom 184R is disposed to the right of the fuselage 181. The right boom 184R is curved in an arcuate shape toward the right. The right boom 184R is connected to a right wing end of the front wing 182. The right boom 184R is connected to a right wing of the rear wing 183. The left boom 184L is disposed to the left of the fuselage 181. The left boom 184L is curved in an arcuate shape toward the left. The left boom 184L is connected to a left wing end of the front wing 182. The left boom 184L is connected to a left wing of the rear wing 183. Moreover, each of the booms 184 may be linearly shaped.

The plurality of first propeller devices 201 are used for takeoff and landing of the aircraft 12. The plurality of first propeller devices 201 are provided respectively on each of the right boom 184R and the left boom 184L. In the present embodiment, each of the right boom 184R and the left boom 184L is equipped respectively with four of the first propeller devices 201. Moreover, each of the right boom 184R and the left boom 184L may be equipped respectively with two, three, or five or more of the first propeller devices 201. In each of the right boom 184R and the left boom 184L, the four first propeller devices 201 are arranged alongside one another respectively in a direction in which the right boom 184R and the left boom 184L extend.

The plurality of second propeller devices 202 are used for cruising of the aircraft 12. The plurality of second propeller devices 202 are provided on the fuselage 181. In the present embodiment, the fuselage 181 is equipped with two of the second propeller devices 202. Moreover, the fuselage 181 may be equipped with one or three or more of the second propeller devices 202. The two second propeller devices 202 are arranged alongside one another on the left and right at a rear end part of the fuselage 181.

As shown in FIG. 2, each of the first propeller devices 201 includes an accommodation unit 22, a drive unit 24, and a propeller 14.

The accommodation unit 22 is equipped with a frame 221, a fairing 222, and a housing 223. The frame 221 is constituted from skeletons of the boom 184. The frame 221 supports the drive unit 24. The frame 221 is connected to the front wing 182 and the rear wing 183. The fairing 222 forms a hole 224 that penetrates in an upward/downward direction. The drive unit 24 is accommodated in the hole 224 of the fairing 222.

The housing 223 is received and supported in the hole 224 in the fairing 222. The housing 223 is made of a metal material and is formed in a cylindrical shape. The housing 223 is equipped with an accommodation hole 26 that penetrates in the upward/downward direction. The accommodation hole 26 of the housing 223 serves to accommodate the propeller drive unit 16.

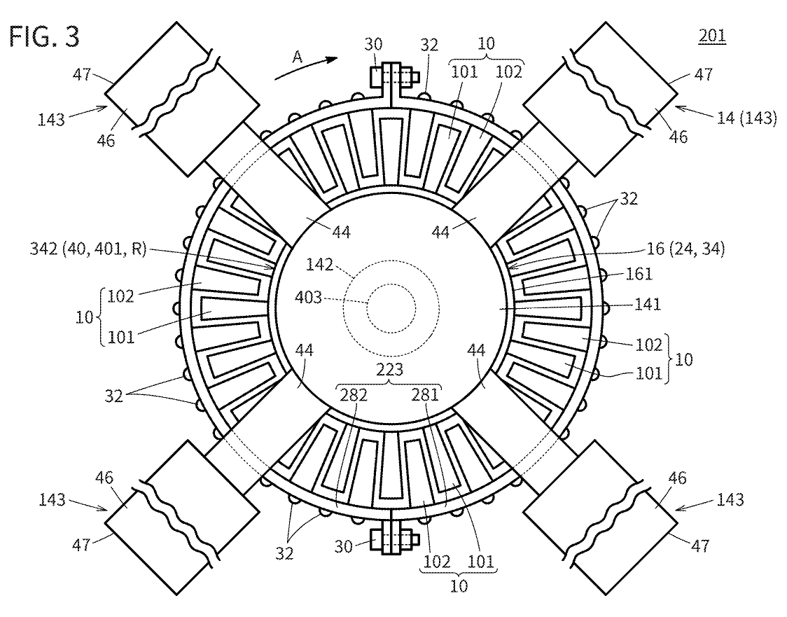

As shown in FIG. 3, the housing 223 is constituted from a first divided body 281 and a second divided body 282 that are capable of being separated from each other in a diametrical direction. When viewed from the axial direction of the housing 223, the first divided body 281 and the second divided body 282 are each respectively half-divided bodies having an arcuately shaped cross section. By both end parts of the first divided body 281 and both end parts of the second divided body 282 being connected to each other, one single housing 223 having a circular shaped cross section is formed. Both end parts of the first divided body 281 and both end parts of the second divided body 282 are connected respectively to each other by a plurality of fastening members 30. Moreover, it should be noted that the housing 223 is not limited to a case of being constituted from a set of divided bodies. For example, the housing 223 may be of an undivided integral shape, or may be constituted by mutually connecting three or more divided bodies together.

An outer peripheral surface of the housing 223 includes a plurality of projecting parts 32. Each of the plurality of projecting parts 32 projects outwardly in a diametrical direction from the outer peripheral surface of the housing 223. The plurality of projecting parts 32 are spaced apart from one another on the outer peripheral surface of the housing 223. By the plurality of projecting parts 32, the surface area of the outer peripheral surface of the housing 223 is increased. Moreover, it should be noted that the projecting parts 32 are not necessarily limited to a case of being disposed in a plurality. For example, one single projecting part 32 may be disposed along the outer peripheral surface of the housing 223. Further, the housing 223 need not necessarily be equipped with the projecting parts 32.

As shown in FIG. 2, the drive unit 24 includes the propeller drive unit 16 and a drive control unit 241. The propeller drive unit 16 causes the propellers 14 to rotate. The propeller drive unit 16 is disposed in the interior of the housing 223. An outer peripheral part 161 of the propeller drive unit 16 faces toward an inner peripheral surface of the housing 223. The propeller drive unit 16 is a motor 34. The motor 34, for example, is an AC motor. The motor 34 includes a stator 341 and a rotor 342. The propeller drive unit 16 is not limited to being the motor 34. For example, the propeller drive unit 16 may be an internal combustion engine.

The stator 341 is fixed to the frame 221. The stator 341 is equipped with a stator core 343, and a winding member 344. A lower part of the stator core 343 is fixed to the frame 221. A plurality of bearings 361 and 362 are provided on the outer peripheral surface of the stator core 343. The plurality of bearings 361 and 362 are rotatably supported on the stator core 343. The plurality of bearings 361 and 362 are disposed to be mutually spaced apart from each other in the axial direction of the stator core 343. The winding member 344 is provided on the outer peripheral part of the stator core 343. A non-illustrated coil is wound around the winding member 344. The winding member 344 is disposed between the bearing 361 and the bearing 362.

The rotor 342 is formed in a cylindrical shape and is disposed outwardly in a diametrical direction of the stator 341. The propeller drive unit 16 (the motor 34) is an outer rotor type motor. The rotor 342 is constituted from a rotor main body 40 and a plurality of magnets 42. The rotor main body 40 is formed in a cylindrical shape. The rotor main body 40 is equipped with a peripheral wall portion 401, an end wall portion 402, and a boss portion 403.

The peripheral wall portion 401 is cylindrically shaped and is formed along the axial direction of the rotor 342. The inner peripheral surface of the peripheral wall portion 401 faces toward the stator 341. The plurality of magnets 42 are disposed on the inner peripheral surface of the peripheral wall portion 401. The plurality of magnets 42 are arranged along a circumferential direction of the rotor main body 40. Each of the plurality of magnets 42 is disposed in a manner so that the magnetic poles thereof differ alternately in the circumferential direction of the rotor main body 40. Each of the plurality of magnets 42 faces toward the winding member 344 of the stator 341. The inner peripheral surface of the peripheral wall portion 401 abuts against the plurality of bearings 361 and 362. The rotor 342 is supported by the plurality of bearings 361 and 362 to be capable of rotating with respect to the stator 341.

The end wall portion 402 is provided at one end part of the peripheral wall portion 401. The end wall portion 402 extends inwardly in a diametrical direction from the peripheral wall portion 401. The boss portion 403 is disposed in a central part of the end wall portion 402. The boss portion 403 projects out in the axial direction from the end wall portion 402. The rotor 342 is capable of relatively rotating with respect to the stator 341. The rotor 342 is a rotating part R that rotates in the propeller drive unit 16.

The drive control unit 241 controls the rotation of the motor 34. The drive control unit 241 includes a non-illustrated inverter circuit, and is disposed on a lower part of the stator 341. An AC electrical power from a non-illustrated electrical power source is supplied via the inverter circuit to a coil (not shown) of the stator 341.

The propellers 14 are disposed upwardly of the accommodation unit 22 and the drive unit 24. Each of the propellers 14 includes a hub portion 141, a propeller shaft 142, and a plurality of blades 143. The propeller shaft 142 is connected to the center of the hub portion 141. The propeller shaft 142 projects out downwardly from the hub portion 141. The propeller shaft 142 is connected to the boss portion 403 of the propeller drive unit 16. At a time when the propeller drive unit 16 is driven, the motor 34 and the propeller 14 rotate integrally together.

As shown in FIG. 3, each of the plurality of blades 143 extends outwardly in a diametrical direction from an outer peripheral surface of the hub portion 141. The plurality of blades 143 are arranged in a radiating shape at equal intervals from one another centrally around the propeller shaft 142. Hereinafter, a description will be given of a case in which each of the propellers 14 is equipped respectively with four blades 143. Moreover, it should be noted that the number of the blades 143 is not necessarily limited to being four. The number of the blades 143 need be at least two.

Each of the blades 143 is equipped with a root portion 44, and a vane portion 46. The root portion 44 is connected to an outer peripheral part of the hub portion 141. The root portion 44 extends outwardly in the diametrical direction from the hub portion 141 without twisting.

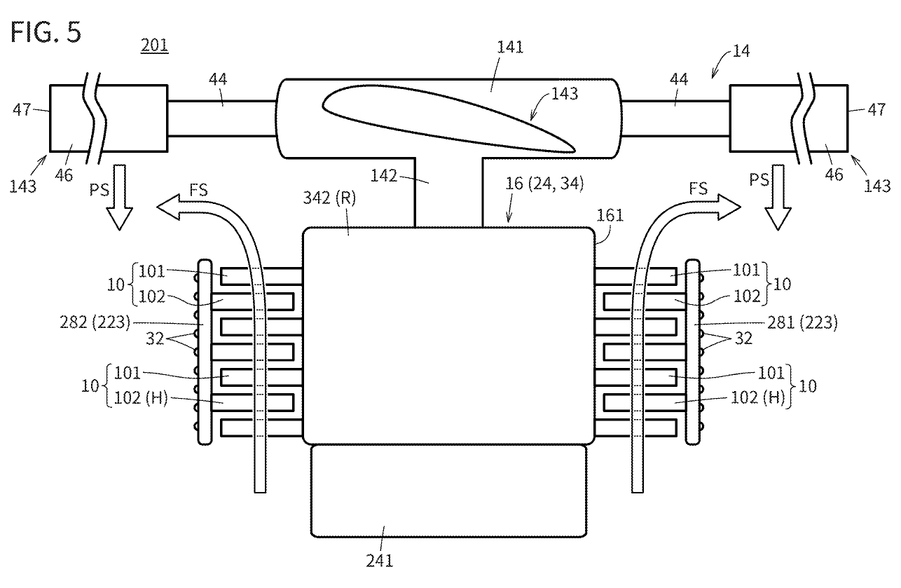

The vane portion 46 is provided between the root portion 44 and a wing end 47 of the blades 143. The vane portion 46 is disposed more outwardly in the diametrical direction than the root portion 44. When viewed in the diametrical direction of the propellers 14, the vane portion 46 is twisted with respect to the root portion 44 and includes a twist angle. At a time when the propellers 14 are rotated, each of the vane portions 46 is capable of generating the propeller airflow PS that is directed downwardly with respect to the aircraft body 18 (refer to FIG. 5).

When viewed in the axial direction of the propellers 14, each of the vane portions 46 is disposed more outwardly in the diametrical direction than the outer peripheral surface of the housing 223. More specifically, when viewed from the axial direction of the propellers 14, the root portion 44 of each of the blades 143 is disposed inwardly in the diametrical direction from the outer peripheral surface of the housing 223.

As shown in FIG. 2, the first propeller devices 201 further include the cooling structure 10. The cooling structure 10 is provided in order to cool the propeller drive unit 16. The cooling structure 10 is equipped with a plurality of fans 101, and a plurality of airflow straightening vanes 102.

The plurality of fans 101 supply a cooling air FS along the outer peripheral part 161 of the propeller drive unit 16 (the motor 34) (refer to FIG. 5). The plurality of fans 101 are provided on the outer peripheral part 161 of the rotor 342 (the propeller drive unit 16). The outer peripheral part 161 includes the peripheral wall portion 401 of the rotor main body 40. The plurality of fans 101 are disposed on the outer peripheral surface of the peripheral wall portion 401 of the rotor main body 40. Each of the plurality of fans 101 is formed in a plate-like shape, and projects outwardly in a diametrical direction from the outer peripheral surface of the peripheral wall portion 401 toward an inner peripheral surface of the housing 223. Each of the fans 101 is spaced apart from the inner peripheral surface of the housing 223.

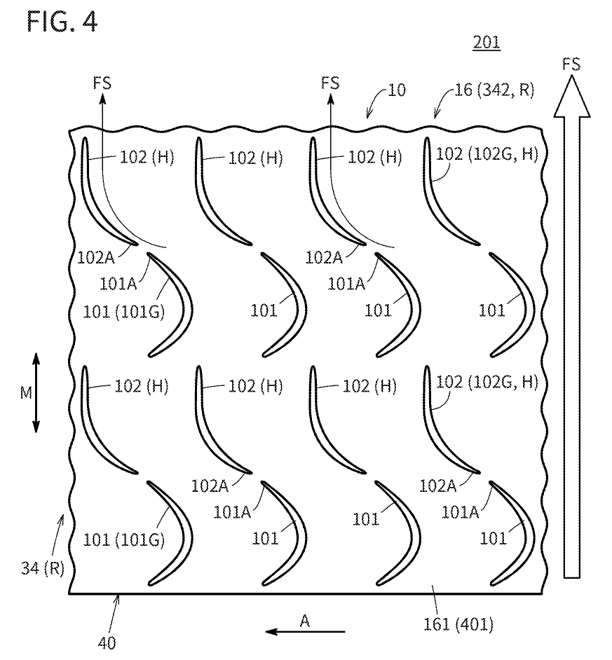

As shown in FIG. 4, when viewed from the diametrical direction of the rotor 342, each of the fans 101 has a curved shape with a center therein recessed in the opposite direction to a direction of rotation A of the rotor 342. Moreover, it should be noted that each of the fans 101 is not limited to a case of being formed in a curved shape. The plurality of fans 101 rotate together with the rotor 342 of the motor 34. The plurality of fans 101 are spaced apart from one another in the circumferential direction of the rotor main body 40. Each of the plurality of fans 101 includes a fan side end part 101A. Each of the fan side end parts 101A, in an axial direction M of the rotor 342 (the rotating part R), is an end part that is disposed on a downstream side in the supply direction of the cooling air FS. Hereinafter, a description will be given concerning a case in which each of the fan side end parts 101A is disposed on an upper part of each of the fans 101. Each of the plurality of fan side end parts 101A is formed in an inclined manner with respect to the axial direction M of the motor 34. Each of the fan side end parts 101A is inclined toward the direction of rotation A with respect to the axial direction M of the rotor 342.

A fan group 101G is formed from a plurality of the fans 101 that are arranged alongside one another in the circumferential direction of the rotor 342. The fan group 101G is disposed in a plurality in the axial direction M of the rotor 342. Each of the plurality of fan groups 101G are spaced mutually apart from one another in the axial direction M of the rotor 342. Hereinafter, a description will be given concerning a case in which four of the fan groups 101G are provided. Moreover, it should be noted that the number of the fan groups 101G is not necessarily limited to being four. For example, the number of the fan groups 101G may be less than or equal to three, or may be greater than or equal to five.

As shown in FIG. 2, from among the four of the fan groups 101G, the fan group 101G that is positioned closest to the propellers 14 is disposed adjacent to an upper end part of the peripheral wall portion 401. From among the four of the fan groups 101G, the fan group 101G that is positioned farthest away from the propellers 14 is disposed adjacent to a lower end part of the peripheral wall portion 401.

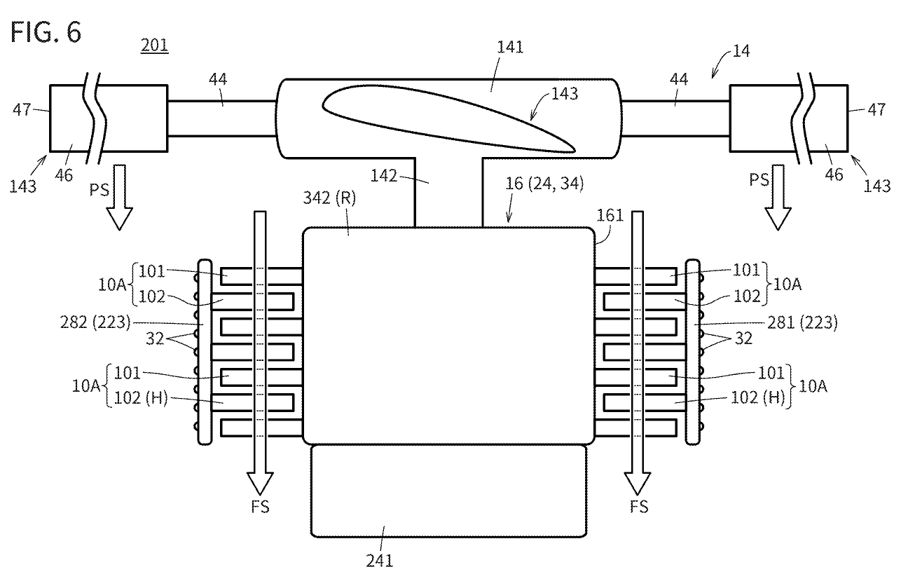

As shown in FIG. 5, by the rotor 342 of the propeller drive unit 16 rotating, the cooling air FS that is blown upwardly by the plurality of fans 101 is generated. The direction in which the propeller airflow PS that is generated by the propellers 14 flows is opposite to the direction in which the cooling air FS flows. Moreover, it should be noted that the flow direction of the propeller airflow PS and the flow direction of the cooling air FS are not necessarily limited to a case of being mutually opposite to each other. As in a cooling structure 10A according to an exemplary modification shown in FIG. 6, for example, the direction in which the propeller airflow PS flows and the direction in which the cooling air FS flows may be the same direction. Specifically, the cooling air FS may flow downwardly in the same direction as the flow of the propeller airflow PS.

The plurality of airflow straightening vanes 102 serve to straighten the cooling air FS that is supplied from the fans 101. As shown in FIG. 2, the airflow straightening vanes 102 are disposed in the interior of the housing 223. Each of the plurality of airflow straightening vanes 102 is disposed on the inner peripheral surface of the housing 223. Each of the plurality of airflow straightening vanes 102 faces toward the outer peripheral part 161 of the propeller drive unit 16. Each of the plurality of airflow straightening vanes 102 is formed in a plate-like shape, and projects out inwardly in a diametrical direction from the inner peripheral surface of the housing 223. Moreover, it should be noted that the plurality of airflow straightening vanes 102 are not necessarily limited to being disposed on the inner peripheral surface of the housing 223. For example, the plurality of airflow straightening vanes 102 may be disposed on the inner peripheral surface of the fairing 222.

As shown in FIG. 4, when viewed from the diametrical direction of the housing 223, each of the airflow straightening vanes 102 is formed to be inclined with respect to an axial line of the housing 223. Each of the plurality of airflow straightening vanes 102 is equipped with a vane side end part 102A. Each of the vane side end parts 102A, in an axial direction of the rotor 342 (the rotating part R), is an end part that is disposed on an upstream side in the supply direction of the cooling air FS. Hereinafter, a description will be given concerning a case in which each of the vane side end parts 102A is disposed on a lower part of each of the airflow straightening vanes 102. Each of the plurality of vane side end parts 102A is formed in an inclined manner with respect to the axial direction M of the motor 34. Each of the vane side end parts 102A is inclined toward an opposite direction to the direction of rotation A with respect to the axial direction M of the rotor 342.

In the axial direction M of the rotor 342, the plurality of fan side end parts 101A and the plurality of vane side end parts 102A face mutually toward one another. In the circumferential direction of the rotor 342, the direction of inclination of each of the fan side end parts 101A and the direction of inclination of each of the vane side end parts 102A are opposite to each other. The angle of inclination of the fan side end parts 101A with respect to the axial direction M of the rotor 342 (the rotating part R), and the angle of inclination of the vane side end parts 102A with respect to the axial direction M of the rotor 342 (the rotating part R) are substantially the same. As shown in FIG. 3, the plurality of airflow straightening vanes 102 are spaced apart from one another in the circumferential direction of the housing 223. Moreover, it should be noted that each of the airflow straightening vanes 102 is not necessarily limited to a case of being inclined with respect to the axial line of the housing 223. For example, each of the airflow straightening vanes 102 may be disposed along the axial line of the housing 223.

A vane group 102G is constituted from a plurality of the airflow straightening vanes 102 that are arranged alongside one another in the circumferential direction of the housing 223. As shown in FIG. 2, the vane group 102G is disposed in a plurality in the axial direction of the housing 223. Each of the plurality of vane groups 102G are spaced mutually apart from one another in the axial direction M of the housing 223. Hereinafter, a description will be given concerning a case in which three of the vane groups 102G are provided. Moreover, it should be noted that the number of the vane groups 102G is not necessarily limited to being three. For example, the number of the vane groups 102G may be less than or equal to two, or may be greater than or equal to four.

In the axial direction M of the rotor 342 of the propeller drive unit 16, each of the plurality of fans 101 (the fan group 101G) and each of the plurality of airflow straightening vanes 102 (the vane group 102G) are disposed alternately. Each of the plurality of vane groups 102G is disposed between each of the plurality of vane groups 101G. Moreover, it should be noted that, in the axial direction M of the rotor 342, each of the plurality of fans 101 and each of the plurality of airflow straightening vanes 102 are not necessarily limited to a case of being disposed alternately. For example, the plurality of fans 101 may be disposed successively alongside one another in the axial direction M, and the plurality of airflow straightening vanes 102 may be disposed successively alongside one another in the axial direction M.

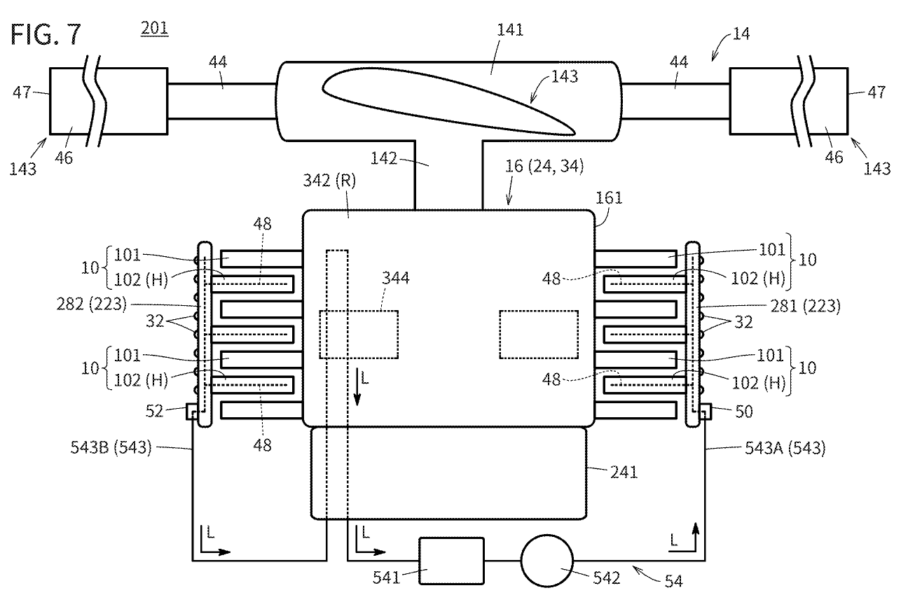

Each of the plurality of airflow straightening vanes 102 is further equipped with a coolant flow unit 48. The coolant flow units 48 are provided respectively in the interior of each of the airflow straightening vanes 102. More specifically, there are a plurality of the coolant flow units 48. A coolant L for the purpose of cooling the propeller drive unit 16 flows through each of the coolant flow units 48 (refer to FIG. 7). The coolant L, for example, is a liquid such as water or a cooling liquid or the like. Moreover, it should be noted that the coolant L is not necessarily limited to being a liquid. For example, the coolant L may be a gas. The coolant flow units 48 are not necessarily limited to a configuration of being disposed in each of the plurality of airflow straightening vanes 102. For example, the coolant flow units 48 may be provided in a portion of the plurality of airflow straightening vanes 102.

The respective plurality of coolant flow units 48 are connected to one another by a non-illustrated common flow path. As shown in FIG. 7, the respective plurality of coolant flow units 48 communicate respectively with a supply port 50 that is disposed in a first divided body 281 of the housing 223. The respective plurality of coolant flow units 48 communicate respectively with a discharge port 52 that is disposed in a second divided body 282 of the housing 223. The respective plurality of coolant flow units 48 communicate respectively via a common flow path with the supply port 50 and the discharge port 52.

The first propeller devices 201 further comprise a cooling system 54. The cooling system 54 is provided in order to cool the stator 341 of the propeller drive unit 16 (refer to FIG. 2), the drive control unit 241, and the like. The cooling system 54 is equipped with a tank 541, a pump device 542, and a piping 543. The cooling system 54 is disposed, for example, on a lower part of the stator 341. The tank 541 is disposed on the stator 341 and stores the coolant L therein. The pump device 542 is driven by electrical power supplied from a non-illustrated electrical power source. By the pump device 542 being driven, the coolant L inside the tank 541 is supplied to the propeller drive unit 16 and the like through the piping 543. Moreover, it should be noted that the tank 541 is not necessarily limited to being disposed on the stator 341. For example, the tank 541 may be disposed in a separate member (a location) that is separate from the stator 341.

The piping 543 is equipped with a supply piping 543A and a discharge piping 543B. The supply piping 543A is connected to a downstream side of the pump device 542. The supply piping 543A is a piping for the purpose of supplying the coolant L that is stored in the tank 541 to the first propeller devices 201.

The supply piping 543A is connected to the supply port 50 of the first divided body 281 of the housing 223. Via the supply port 50, each of the coolant flow units 48 of the plurality of airflow straightening vanes 102 communicate respectively with the supply piping 543A.

The discharge piping 543B is connected to an upstream side of the tank 541. The discharge piping 543B is a piping for the purpose of returning the coolant L to the tank 541 after having cooled the first propeller devices 201. The discharge piping 543B is connected to the discharge port 52. Via the discharge port 52, each of the coolant flow units 48 of the plurality of airflow straightening vanes 102 communicate respectively with the discharge piping 543B.

By the plurality of airflow straightening vanes 102, heat is exchanged between the coolant L that flows through each of the coolant flow units 48 and the cooling air FS that is placed in contact with each of the airflow straightening vanes 102. The plurality of airflow straightening vanes 102 function as a heat exchange unit H. The coolant L that has become heated due to cooling of the first propeller devices 201 is cooled again by the plurality of airflow straightening vanes 102. The coolant L that has been cooled passes through the discharge piping 543B and circulates to the tank 541.

A description will be given concerning a case in which the propeller drive unit 16 is cooled by the cooling structure 10 according to the present embodiment.

Electrical power is supplied from a non-illustrated electrical power source (for example, a battery) to each of the first propeller devices 201 and the second propeller devices 202 of the aircraft 12. When the electrical power is supplied to the stator 341 in the first propeller devices 201, the coil of the stator 341 is excited. By the coil being excited, the rotor main body 40, on which there are fitted the plurality of magnets 42 that serve as magnetic poles, rotates relatively on the outer peripheral side of the stator 341. At this time, the direction of rotation A of the rotor 342 is the first direction (the direction of the arrow A) (refer to FIG. 3).

By the rotor main body 40 undergoing rotation, the propellers 14 rotate centrally around the propeller shaft 142. By the propellers 14 undergoing rotation, as shown in FIG. 5, a downwardly directed propeller airflow PS (a downwash) is generated by the plurality of vane portions 46. In accordance with this feature, on the aircraft body 18 of the aircraft 12, a thrust force is generated by the rotation of the propellers 14 that causes the aircraft to rise.

By the rotation of the rotor main body 40, the plurality of fans 101 rotate in the interior of the housing 223. By the plurality of fans 101 undergoing rotation, an upwardly directed cooling air FS is generated between the housing 223 and the rotor 342 (the outer peripheral part 161 of the propeller drive unit 16) that constitutes the motor 34. The cooling air FS flows upwardly along the outer peripheral surface of the rotor main body 40. At this time, the rotation of the plurality of fans 101 causes the cooling air FS to become a swirling flow along the direction of rotation of the fans 101.

When the cooling air FS rises in the interior of the housing 223, while rising upward, the cooling air FS comes into contact with each of the airflow straightening vanes 102 in the plurality of vane groups 102G. Due to the contact between each of the airflow straightening vanes 102 and the cooling air FS, the swirling component of the cooling air FS is canceled out and reduced. In accordance with this feature, the cooling air FS inside the housing 223 is straightened.

The cooling air FS, which has been straightened by the plurality of airflow straightening vanes 102, flows upwardly in a substantially straight line in the interior of the housing 223. The cooling air FS is discharged to the exterior from the upper end part of the housing 223. When the cooling air FS comes into contact with the housing 223, the heat of the cooling air FS is dissipated via the housing 223.

In the cooling system 54 shown in FIG. 7, electrical power is supplied from a non-illustrated electrical power source to the pump device 542. By the pump device 542 being driven, the coolant L inside the tank 541 passes through the supply piping 543A, and is supplied to the supply port 50 of the first propeller devices 201. The coolant L passes from the supply port 50 through a common flow path (not shown), and is supplied to each of the plurality of coolant flow units 48.

In a state in which the coolant L has circulated through each of the coolant flow units 48 of the plurality of airflow straightening vanes 102, by the cooling air FS and each of the airflow straightening vanes 102 coming into contact, heat exchange is carried out between the cooling air FS and the coolant L. The cooling air L is cooled by the cooling air FS. More specifically, the plurality of airflow straightening vanes 102 function as the heat exchange unit H. In addition, the coolant L passes through the discharge port 52 and is discharged into the discharge piping 543B. The coolant L that flows through the discharge piping 543B, by flowing along each of the stator 341 and the drive control unit 241, serves to respectively cool each of the stator 341 and the drive control unit 241. Moreover, it should be noted that the heat exchange unit H is not necessarily limited to a case of being constituted from the plurality of airflow straightening vanes 102 that are equipped with the coolant flow units 48. For example, a heat exchanger which is capable of exchanging heat between the coolant L and the air may be connected to the piping 543.

After each of the stator 341 and the drive control unit 241 have been cooled, the coolant L, after having passed through the discharge piping 543B and returned to the tank 541, is supplied again to the first propeller devices 201.

The present embodiment accomplishes the following advantageous effects.

As shown in FIG. 2, the cooling structure 10 cools the propeller drive unit 16 that is made to rotate and thereby drives the propellers 14 of the aircraft 12. The cooling structure 10 is equipped with the fans 101 that supply the cooling air FS to the outer peripheral part 161 of the propeller drive unit 16, and the airflow straightening vanes 102 that serve to straighten the cooling air FS.

In accordance with this configuration, by the cooling air FS being straightened by the airflow straightening vanes 102, the swirling component of the cooling air FS is effectively reduced, and an increase in the loss of pressure is suppressed. In accordance therewith, the cooling air FS that has been straightened can flow effectively along the outer peripheral part 161 of the propeller drive unit 16, and the cooling performance of the propeller drive unit 16 can be enhanced. Further, in the interior of the housing 223, by the cooling air FS flowing along the outer peripheral part 161 of the rotor 342, the outer peripheral part 161 is cooled by the cooling air FS. Therefore, the heat that is generated by the driving of the propeller drive unit 16 is cooled by the cooling air FS.

The airflow straightening vanes 102 are disposed in the interior of the housing 223 in which the propeller drive unit 16 is accommodated. The airflow straightening vanes 102 face toward the outer peripheral part 161 of the propeller drive unit 16.

In accordance with such a configuration, by the housing 223, the cooling air FS is capable of flowing effectively along the outer peripheral part 161 of the propeller drive unit 16. The effect of straightening the cooling air FS by the airflow straightening vanes 102 can be further enhanced.

The fans 101 and the airflow straightening vanes 102 are disposed respectively in a plurality. In the axial direction M of the rotating part R that is provided in the propeller drive part 16, each of the plurality of fans 101 and each of the plurality of airflow straightening vanes 102 are disposed alternately.

In accordance with this configuration, the flow velocity of the cooling air FS, whose flow velocity has been reduced by the airflow straightening vanes 102, can be increased by the fans 101 that are adjacent to the airflow straightening vanes 102. Therefore, the flow velocity of the cooling air FS that flows between the airflow straightening vanes 102 and the fans 101 is effectively maintained.

The propeller drive unit 16 is the motor 34. In accordance with this configuration, at a time when the motor 34 is being driven, the propeller drive unit 16 can be effectively cooled by the cooling air FS.

The motor 34 is equipped with the rotor 342 that is disposed outwardly in the diametrical direction of the stator 341. The fans 101 rotate together with the rotor 342. In accordance with this configuration, by the rotor 342 being made to rotate, the cooling air FS can be generated effectively.

The airflow straightening vanes 102 are mounted in the housing 223 in which the propeller drive unit 16 is accommodated. In accordance with this configuration, by providing the airflow straightening vanes 102 in the housing 223, the cooling air FS that is generated by the fans 101 that rotates together with the rotor 342 can be effectively straightened.

As shown in FIG. 5, the propellers 14 are capable of generating the propeller airflow PS that is directed downwardly with respect to the aircraft body 18 of the aircraft 12. The direction in which the propeller airflow PS flows is opposite to the direction in which the cooling air FS flows. In accordance with this configuration, when dust particles or the like contained within the propeller airflow PS adhere to the airflow straightening vanes 102, by the accumulated dust particles or the like falling downwardly due to their own weight or due to the vibration of the aircraft 12 when the propeller drive unit 16 (the motor 34) is stopped, an increase in the intake resistance when the cooling air FS flows along the housing 223 can effectively be suppressed.

As shown in FIG. 3, each of the plurality of blades 143 of the propellers 14 is equipped with the root portion 44 that extends outwardly in the diametrical direction from the hub portion 141 without twisting, and the vane portion 46 that is twisted with respect to the root portion 44 with a twist angle, and is capable of generating the propeller airflow PS. When viewed in the axial direction of the propellers 14, the vane portions 46 are disposed more outwardly in the diametrical direction than the housing 223.

In accordance with this configuration, interference between the airflow generated by the vane portions 46 (the propeller airflow PS) and the airflow generated by the fans 101 inside the housing 223 (the cooling air FS) is suppressed. Therefore, the airflow generated by the fans 101 can be efficiently circulated between the housing 223 and the propeller drive unit 16.

As shown in FIG. 2, the airflow straightening vanes 102 are equipped in the interior thereof with the coolant flow units 48 through which the coolant L flows. In accordance with this configuration, by the airflow straightening vanes 102 being cooled by the coolant L, the cooling air FS flowing between the airflow straightening vanes 102 and the fans 101 can be effectively cooled.

As shown in FIG. 7, the coolant L serves to cool the propeller drive unit 16. In accordance with this configuration, the cooling air FS can be effectively cooled by the coolant L.

As shown in FIG. 3, the outer peripheral surface of the housing 223 is equipped with the projecting parts 32. In accordance with this configuration, the surface area of the housing 223 is increased by the projecting parts 32, and the cooling effect can be effectively enhanced.

As shown in FIG. 4, in the axial direction M of the rotating part R (the rotor 342), each of the plurality of fans 101 includes the fan side end part 101A that is disposed on a downstream side in the flow direction of the cooling air FS. Each of the plurality of airflow straightening vanes 102 includes the vane side end part 102A that is disposed on an upstream side in the flow direction of the cooling air FS, and that faces toward the fan side end part 101A. Each of the plurality of fan side end parts 101A and the plurality of vane side end parts 102A is formed respectively at an inclination with respect to the axial direction M, and the angle of inclination of the fan side end parts 101A with respect to the axial direction M may be approximately the same as the angle of inclination the vane side end parts 102A with respect to the axial direction M. In accordance with this configuration, it is possible to effectively suppress the loss of speed (the energy loss) of the cooling air FS that is discharged by the plurality of fans 101.

As shown in FIG. 6, the direction in which the propeller airflow PS flows and the direction in which the cooling air FS flows may be the same direction. In accordance with this configuration, a portion of the propeller airflow PS can be taken in as the cooling air FS, and can be effectively used to cool the propeller drive unit 16.

Concerning the above-described disclosure, the following supplementary notes are further disclosed.

### Supplementary Note 1

The cooling structure (10, 10A) for cooling the propeller drive unit (16) that rotates and drives the propellers (14) of the aircraft (12) is equipped with the fans (101) that supply the cooling air (FS) to the outer peripheral part (161) of the propeller drive unit, and the airflow straightening vanes (102) that serve to straighten the cooling air.

In accordance with such a configuration, by the cooling air being straightened by the airflow straightening vanes, an increase in the loss of pressure is suppressed, and the cooling air can effectively flow to the outer peripheral part of the propeller drive unit. Therefore, the cooling performance of the propeller drive unit can be enhanced.

### Supplementary Note 2

In the cooling structure according to Supplementary Note 1, there may further be provided the housing (223) in which the propeller drive unit is accommodated, wherein the airflow straightening vanes are disposed in the interior of the housing and face toward the outer peripheral part of the propeller drive unit. In accordance with such a configuration, by the housing, the cooling air is capable of flowing effectively to the outer peripheral part of the propeller drive unit. The effect of straightening the cooling air by the airflow straightening vanes can be further enhanced.

### Supplementary Note 3

In the cooling structure according to Supplementary Note 1 or 2, the fans and the airflow straightening vanes may be provided respectively in a plurality, and each of the plurality of fans and each of the plurality of airflow straightening vanes may be disposed alternately in the axial direction (M) of the rotating part (R) provided in the propeller drive unit. In accordance with such a configuration, the flow velocity of the cooling air, whose flow velocity has been reduced by the airflow straightening vanes, can be increased by the fans that are adjacent to the airflow straightening vanes. Therefore, the flow velocity of the cooling air that flows between the airflow straightening vanes and the fans is effectively maintained.

### Supplementary Note 4

In the cooling structure according to Supplementary Note 1, in the propeller drive unit, there may be the motor (34). In accordance with such a configuration, at a time when the motor is being driven, the propeller drive unit can be effectively cooled by the cooling air.

### Supplementary Note 5

In the cooling structure according to Supplementary Note 4, the motor may comprise the stator (341), and the rotor (342) to which the propeller is connected, and further, which is disposed outwardly in a diametrical direction of the stator and rotates relatively with respect to the stator, and the fan rotates together with the rotor of the motor. In accordance with such a configuration, by the rotor being made to rotate, the cooling air can be generated effectively.

### Supplementary Note 6

The cooling structure according to Supplementary Note 4 or 5, wherein the motor may comprise the stator, and the rotor to which the propeller is connected, and further, which is disposed outwardly in a diametrical direction of the stator and rotates relatively with respect to the stator, and the airflow straightening vanes may be mounted in the housing in which the propeller drive unit is accommodated. In accordance with such a configuration, by providing the airflow straightening vanes in the housing, the cooling air that is generated by the fan that rotates together with the rotor can be effectively straightened.

### Supplementary Note 7

In the cooling structure according to any one of Supplementary Notes 1 to 6, the propeller may be capable of causing the propeller airflow (PS) that flows downwardly with respect to the aircraft body (18) of the aircraft to be generated, and the propeller airflow may flow in the opposite direction to the direction in which the cooling air flows. In accordance with such a configuration, when dust particles contained or the like within the propeller airflow adhere to the airflow straightening vanes, by the accumulated dust particles or the like falling downwardly due to their own weight or due to the vibration of the aircraft when the propeller drive unit (the motor) is stopped, an increase in the intake resistance when the cooling air FS flows can be suppressed.

### Supplementary Note 8

In the cooling structure according to any one of Supplementary Notes 1 to 7, the propeller may include the hub portion (141), and the plurality of blades (143) that are extended outwardly in the diametrical direction of the hub portion, each of the plurality of blades may comprise the root portion (44) that extends outwardly in the diametrical direction from the hub portion without twisting, the vane portion (46) that is disposed between the root portion and the wing end (47), and which is twisted at a twisting angle with respect to the root portion, and which is capable of generating the propeller airflow, wherein the direction in which the propeller airflow flows and the direction in which the cooling air flows may be opposite to each other, and when viewed from the axial direction of the propeller, the blade portion may be disposed more outwardly in the diametrical direction than the propeller. In accordance with such a configuration, interference between the airflow generated by the vane portions (the propeller airflow) and the airflow generated by the fan inside the housing (the cooling air) is suppressed. Therefore, the airflow generated by the fans can be efficiently circulated between the housing and the propeller drive unit.

### Supplementary Note 9

In accordance with the cooling structure according to any one of Supplementary Notes 1 to 8, the airflow straightening vanes may be equipped with the coolant flow unit (48) in the interior thereof through which the coolant (L) flows. In accordance with such a configuration, by the airflow straightening vanes being cooled by the coolant, the cooling air that flows between the airflow straightening vanes and the fans can be effectively cooled.

### Supplementary Note 10

In the cooling structure according to Supplementary Note 9, the coolant may cool the propeller drive unit. In accordance with such a configuration, the cooling air can be effectively cooled by the coolant.

### Supplementary Note 11

In the cooling structure according to Supplementary Note 2, the outer peripheral surface of the housing may be equipped with the projecting part (32). In accordance with such a configuration, the surface area of the housing is increased by the projecting part, and the cooling effect can be effectively enhanced.

### Supplementary Note 12

In the cooling structure according to Supplementary Note 3 or 4, in the axial direction of the rotating part, each of the plurality of fans may include the fan side end part (101A) that is disposed on the downstream side of the flow direction of the cooling air in the fans, and each of the airflow straightening vanes may include the vane side end parts (102A) that are disposed on the upstream side of the airflow straightening vanes in the flow direction of the cooling air, and that face toward the fan side end parts, and each of the plurality of fan side end parts and the plurality of vane side end parts may be formed in an inclined manner with respect to the axial direction, and further the angle of inclination of the fan side end parts with respect to the axial direction may be substantially the same as the angle of inclination of the vane side end parts with respect to the axial direction. In accordance with such a configuration, it is possible to effectively suppress the loss of speed (the energy loss) of the cooling air that is discharged by the plurality of fans.

Although concerning the present disclosure, a detailed description thereof has been presented above, the present disclosure is not necessarily limited to the individual embodiments described above. These embodiments may be subjected to various additions, substitutions, modifications, partial deletions and the like, within a range that does not deviate from the essence and gist of the present disclosure, or the spirit of the present disclosure as derived from the content described in the claims and equivalents thereof. Further, the embodiments can also be implemented together in combination. For example, in the above-described embodiments, the order of each of the operations and the order of each of the processes are illustrated as examples, and the present invention is not necessarily limited to these features. Further, the same also applies to cases in which numerical values or mathematical expressions are used in the description of the aforementioned embodiments.

1. A cooling structure for cooling a propeller drive unit configured to rotate and drive an aircraft propeller, the cooling structure comprising:
a fan configured to supply a cooling air to an outer peripheral part of the propeller drive unit; and
an airflow straightening vane configured to straighten the cooling air.

2. The cooling structure according to claim 1, further comprising a housing in which the propeller drive unit is accommodated, wherein the airflow straightening vane is disposed in an interior of the housing and faces toward the outer peripheral part of the propeller drive unit.

3. The cooling structure according to claim 1, wherein
the fan and the air guide vane are provided respectively in a plurality, and
each of the plurality of fans and each of the plurality of airflow guide vanes are disposed alternately in the axial direction of a rotating part provided in the propeller drive unit.

4. The cooling structure according to claim 1, wherein the propeller drive unit is a motor.

5. The cooling structure according to claim 4, wherein
the motor comprises:
a stator; and
a rotor to which the propeller is connected, and further, which is disposed outwardly in a diametrical direction of the stator and is configured to rotate relatively with respect to the stator, and
the fan rotates together with the rotor of the motor.

6. The cooling structure according to claim 4, wherein
the motor comprises:
a stator; and
a rotor to which the propeller is connected, and further, which is disposed outwardly in a diametrical direction of the stator and is configured to rotate relatively with respect to the stator, and
the airflow straightening vane is mounted in a housing in which the propeller drive unit is accommodated.

7. The cooling structure according to claim 1, wherein
the propeller is capable of generating a propeller airflow that flows downwardly with respect to an aircraft body of the aircraft, and
the propeller airflow flows in an opposite direction to the direction in which the cooling air flows.

8. The cooling structure according to claim 2, wherein
the propeller comprises:
a hub portion; and
a plurality of blades configured to be extended outwardly in a diametrical direction of the hub portion,
each of the plurality of blades comprises:
a root portion configured to extend outwardly in a diametrical direction from the hub portion without twisting; and
a blade portion disposed between the root portion and a blade end, and configured to be twisted at a twisting angle with respect to the root portion, and to be capable of generating a propeller airflow,
a direction in which the propeller airflow flows and a direction in which the cooling air flows are opposite to each other, and
when viewed from an axial direction of the propeller, the vane portion is disposed more outwardly in the diametrical direction than the propeller.

9. The cooling structure according to claim 1, wherein the airflow straightening vane comprises a coolant flow portion in an interior thereof through which a coolant flows.

10. The cooling structure according to claim 9, wherein the coolant cools the propeller drive unit.

11. The cooling structure according to claim 2, wherein an outer peripheral surface of the housing comprises a projecting part.

12. The cooling structure according to claim 3, wherein
in the axial direction of the rotating part, each of the plurality of fans comprises a fan side end part that is disposed on a downstream side of a flow direction of the cooling air in the fan,
each of the airflow straightening vanes comprises a vane side end part that is disposed on an upstream side of the airflow straightening vane in the flow direction of the cooling air, and that faces toward the fan side end part, and
each of the plurality of fan side end parts and the plurality of vane side end parts is formed in an inclined manner with respect to the axial direction, and an angle of inclination of the fan side end part with respect to the axial direction is substantially the same as an angle of inclination of the vane side end parts with respect to the axial direction.
